(19) United States
(12) Patent Application Publication
(10) Pub. No.: US 2018/0027230 A1
(43) Pub. Date: Jan. 25, 2018

(54) Adjusting Parallax Through the Use of Eye Movements

(71) Applicant: John T. Kerr, San Mateo, CA (US)

(72) Inventor: John T. Kerr, San Mateo, CA (US)

(21) Appl. No.: 15/214,000

(22) Filed: Jul. 19, 2016

(51) Int. Cl. H04N 13/04; H04N 13/00; G06T 19/00; A63F 13/20; G06F 3/01; A63F 13/25; A63F 13/335; A63F 13/65; G02B 27/01; G06T 19/20

(52) U.S. Cl. CPC H04N 13/0484; G02B 27/017; H04N 13/0022; H04N 13/044; H04N 13/0059; G06T 19/006; G06T 19/20; G06F 3/013; A63F 13/25; A63F 13/335; A63F 13/65; A63F 13/20; G02B 2027/014; G02B 2027/0138; A63F 2300/8082

(57) ABSTRACT

A method includes steps for collecting gaze data establishing eye position and changes in eye position over time by a first imaging device fixed in position relative to a player viewing a display of a virtual reality environment on a screen fixed relative to the imaging device, and focused to image a first eye of the player, providing the gaze data to a first data repository coupled to a processor that is determining and serving display data for rendering the virtual environment in the display, determining gaze direction for the player's first eye relative to a coordinate system associated with the virtual environment, determining parallax effects for objects in the display by the processor at least in part dependent on the gaze direction, and modifying the display data server to position objects in the display according to the parallax effects determined.

### BACKGROUND OF THE INVENTION

### 1. Field of the Invention

The present invention is in the technical field of 3D rendering of virtual environments.

### 2. Description of Related Art

Since the first video gaming machines arrived in the early 1970s, innovation and video games have always gone hand-in-hand. This technology started with machines that were capable of displaying two colors on screen, a simple controller for input, and rudimentary graphical capabilities. Today, we have video games with graphics that are almost indiscernible from photographs, as well as numerous methods for controlling actions in a video game.

Recently, substantial advancements have been made in the field of virtual reality. With consumer release of head mounted displays, such as, for example, HTC's Vive and the Oculus Rift, there has been a sharp increase in interest in virtual reality, including research in player experiences, content of all types, and additional methods of input to further immerse the player in a virtual reality. However, the technology isn't perfect. Due to limitations in the current technology in both rendering and oversight of human physiology, many users report instances of virtual reality induced motion sickness. For example, if a player is immersed in a virtual world is looking in one direction and expecting to move in that direction, but is suddenly moving in another direction by the system, the player's brain tries to accommodate for the perceived anomaly and the player may experience motion sickness. It is believed that with improved rendering techniques applied in a virtual reality that more accurately portrays what the brain expects in actual reality, that virtual reality-induced motion sickness can be decreased. These same improvements may also improve the overall experience for players of virtual reality games. Therefore, what is clearly needed are continual improvements to the realism in which virtual environments are rendered.

### BRIEF SUMMARY OF THE INVENTION

In one embodiment on the invention a method is provided, comprising collecting gaze data establishing eye position and changes in eye position over time by a first imaging device fixed in position relative to a player viewing a display of a virtual reality environment on a screen fixed relative to the imaging device, and focused to image a first eye of the player, providing the gaze data to a first data repository coupled to a processor that is determining and serving display data for rendering the virtual environment in the display, determining gaze direction for the player's first eye relative to a coordinate system associated with the virtual environment, determining parallax effects for objects in the display by the processor at least in part dependent on the gaze direction, and modifying the display data server to position objects in the display according to the parallax effects determined.

Also in one embodiment the screen is a single opaque screen in a head-mounted device. Also, in one embodiment of the invention the display is a head-mounted device with semi-transparent screens. Also in one embodiment the display is a stand-alone display monitor. Also in one embodiment the processor and data repository are components of computer circuitry implemented local to the display screen. Also in one embodiment the processor and data repository are components of a network-connected server remote from the imaging device and the display screen, wherein the gaze data is transmitted over the network to the network-connected server, the gaze direction and parallax effects are determined by the processor at the network-connected server, and the display data is transmitted over the network from the network-connected server to the display screen. Also in one embodiment a second camera is focused on a second eye of the player, providing gaze data for the second eye to the data repository, wherein gaze direction and parallax effects are determined for both of the player's eyes.

In another aspect of the invention a system is provided, comprising a first imaging device fixed in position relative to a player viewing a display of a virtual reality environment on a screen fixed relative to the imaging device, and focused to image a first eye of the player, the first imaging device collecting gaze data establishing eye position and changes in eye position over time, and a first data repository coupled to a processor that is determining and serving display data for rendering the virtual environment in the display, the data repository receiving the gaze data from the first imaging device, wherein the processor determines gaze direction for the player's first eye relative to a coordinate system associated with the virtual environment, determines parallax effects for objects in the display, at least in part dependent on the gaze direction, and modifies the display data served to position objects in the display according to the parallax effects determined.

Also, in one embodiment the screen is a single opaque screen in a head-mounted device. Also in one embodiment the display is a head-mounted device with semi-transparent screens. Also in one embodiment the display is a stand-alone display monitor. Also in one embodiment the processor and data repository are components of computer circuitry implemented local to the display screen. Also in one embodiment the processor and data repository are components of a network-connected server remote from the imaging device and the display screen, wherein the gaze data is transmitted over the network to the network-connected server, the gaze direction and parallax effects are determined by the processor at the network-connected server, and the display data is transmitted over the network from the network-connected server to the display screen. Also in one embodiment a second camera is focused on a second eye of the player, providing gaze data for the second eye to the data repository, wherein gaze direction and parallax effects are determined for both of the player's eyes.

### BRIEF DESCRIPTION OF THE SEVERAL VIEWS OF THE DRAWINGS

FIG. 1a is the top view of an example head-mounted device with opaque screens with installed imaging devices.

FIG. 1b is the top view of an example head-mounted device with semi-transparent screens installed imaging devices.

FIG. 1c is the top view of a standard monitor with an installed imaging device.

FIG. 2 is an example of a system that various embodiments of the inventive concept may be implemented.

FIG. 3 illustrates one method in which a focal point in a virtual environment is determined.

FIG. 4a is a top-view illustration of an eye positioned to look forward at two posts.

FIG. 4b is an illustration of a simulated view of what might be seen from looking at two posts straight-on.

FIG. 5a is a top-view illustration of an eye turned to the left with two posts in its periphery.

FIG. 5b is an illustration of a simulated view of how two posts might appear in the periphery when an eye turns to the left.

FIG. 6a is a top-view illustration of an eye turned to the right with two posts in its periphery.

FIG. 6b is an illustration of a simulated view of how two posts might appear in the periphery when an eye turns to the right.

FIG. 7 is an illustration of a method for gathering gaze data and processing it to modify the display data to apply a parallax effect according to one embodiment of the present invention.

FIG. 8 is an example of a network architecture used in various embodiments.

### DETAILED DESCRIPTION OF THE INVENTION

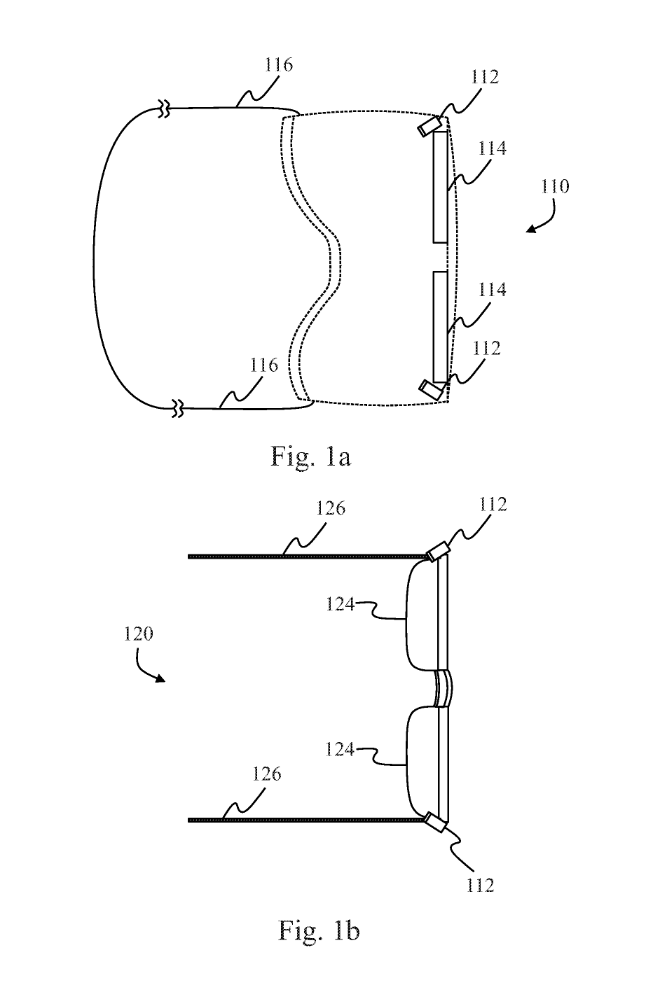

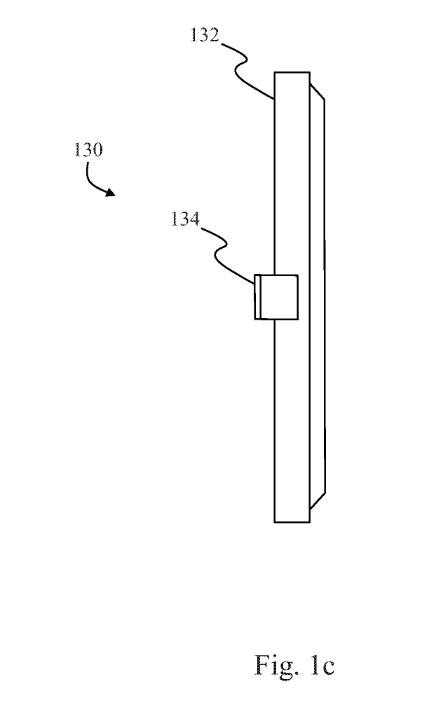

FIG. 1a shows an example of a head-mounted device 110 that has opaque screens 114. Imaging devices 112 may be fixed into position beside the screens, and angled to collect gaze data of the user of head-mounted device 110. The drawing illustrates two imaging devices 112, and should be taken only as an example, as in some embodiments just one imaging device may be present. The gaze data collected may consist of, but not limited to, eye position, changes in eye position over time, iris shapes and sizes, pupillary responses, and pupillary changes over time. The data on eye positioning, and changes in eye position over time will be used by the system to determine a parallax effect as described below. The data found from the iris may be used to further enhance the experience of the player that may consist of, but is not limited to, depth of field or gauging the interest a player shows in the object of their focus. The head-mounted device 110 may strap around the player's head with head straps 116 of adjustable length. It will be apparent to the skilled person that the data collected by the imaging devices is raw image data, and that processing will be necessary to interpret the raw data, and to use it enhancing the display of virtual reality environments. Such processing is described further below.

FIG. 1b shows an example of a head-mounted device 120 that contains a semi-transparent lens with screens 124. Imaging devices 112 may be mounted on device 120 at a point where a temple 126 attaches to the screens 124. Imaging device 112 would be angled in order to collect gaze data of the user of the head-mounted device 120.

FIG. 1c shows an example of an imaging device 134 fixed to a stand-alone monitor 132. Imaging device 134 might be set into position to be able to collect gaze data from the user's eyes. The illustration shows the camera positioned in the center, but it is understood that imaging device 134 may be placed in any position where the user's eyes are still visible to imaging device 134. Also, it may be possible to use more than one imaging device 134 for the purpose of collecting gaze data.

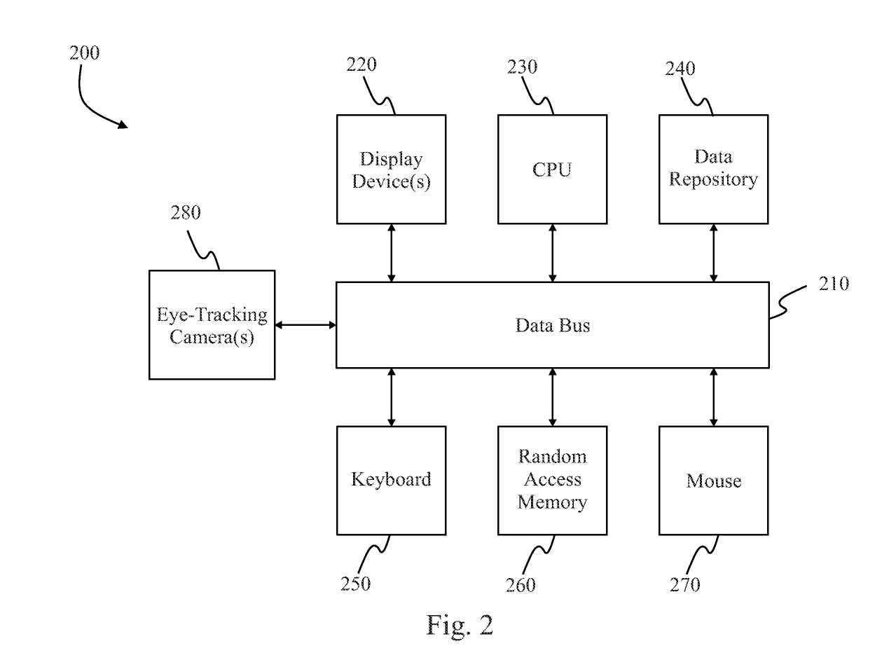

FIG. 2 shows an example computer system 200 in which various embodiments of the inventive concept may be implemented. Computer system 200 may have a data bus 210 which allows all the components to communicate with one another. The components that may be connected to data bus 210 are, but not limited to, a display device 220, a central processing unit (CPU) 230, a data repository 240, a computer keyboard 250, a form of random access memory (RAM) 260, a computer mouse 270, and imaging devices configured to collect gaze data 280. Display device 220 may consist of, but not limited to, a stand-alone monitor, or a head-mounted device as shown in example in FIGS. 1a-1b. CPU 230 is responsible for executing coded instructions commonly stored on data repository 240, and also, in some instances, RAM 260. Data repository 240 may be any form of storage that is known in the art. Such data repositories are commonly used as a way to store documents, files, and instructions for usage in the long-term.

Keyboard 250 may be any type of input method used in the art for input of characters. RAM 260 may be any type of memory used in the art for short-term storage of information. RAM 260 is usually faster in read and write speed than what is commonly used for data repository 240, but may not be used as storage for files that will not be accessed for extended periods of time. The user may also not be able to directly control what files or instructions are written to or read from RAM 260. That task may be, instead, managed by the processor and the operating instructions stored on data repository 240. Computer mouse 270 may consist of any form of cursor control known in the art. Hardware normally used for this purpose may consist of, but not limited to, an optical mouse, a trackball, or a touchpad. For the techniques taught by the present invention, this computer system may utilize an imaging device 280, to collect gaze data of the player and stored on data repository 240. Imaging device 280 may consist of any device known in the art for used for imaging usage, and may be specialized imaging hardware or general-use imaging devices.

The computer architecture illustrated in FIG. 2 and described here may be that of a general-computer platform, such as a personal computer, to which a head-mounted display may be connected, either hardwired or wirelessly. In some embodiments virtual reality presentations, such as games, may be stored in data repository 240, and processing and display streaming may be done locally. In other embodiments the local system depicted may be connected to a network, such as the Internet network, and image data may be transmitted via the network to one or more network-connected servers where processing of the image data may take place, and virtual reality presentations may be served to the local system depicted in FIG. 2, and to a plurality of other remote users.

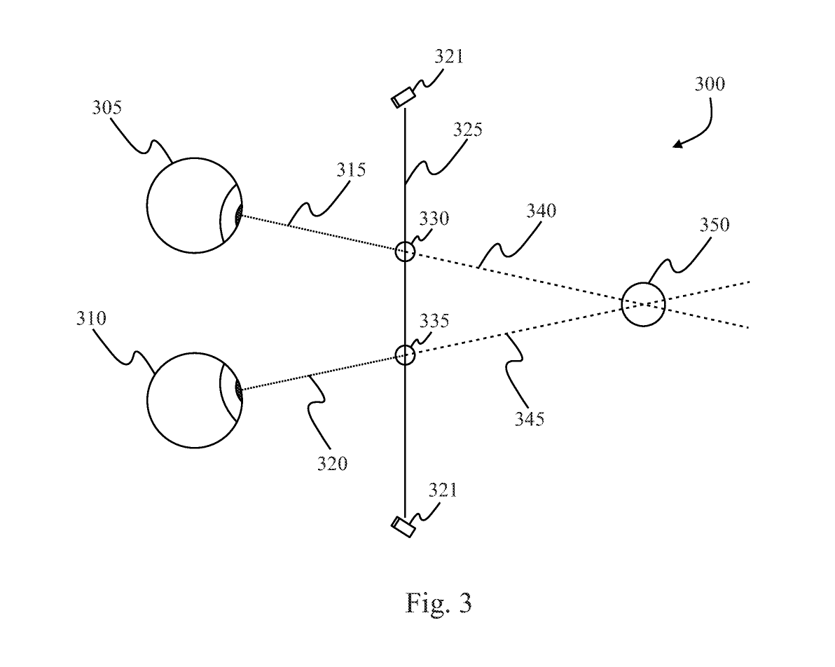

FIG. 3 demonstrates one method of determining a focal point 350 in a virtual environment 300. A left eye 305 and a right eye 310 are monitored by imaging devices 321 mounted in a manner as demonstrated by FIGS. 1a-1c. FIG. 3 depicts a setup with two imaging devices, but it should be understood that it is also possible to use a single imaging device as shown in FIG. 1c, or using any number of imaging devices 321. Imaging devices 321 are configured to determine a left-eye view direction 315, and a right-eye view direction 320 as it makes contact with a screen surface 325 at a left-eye contact point 330 and a right-eye contact point 335. A left-eye trajectory 340 and a right-eye trajectory 345 are extrapolated by the system based on gaze data gathered by imaging devices 321. Left-eye trajectory 340 and right-eye trajectory 345 intersect at a focal point 350 that is determined by the system as the area around the point of intersection of left-eye trajectory 340 and right-eye trajectory 345 in a virtual reality environment having a specific coordinate system.

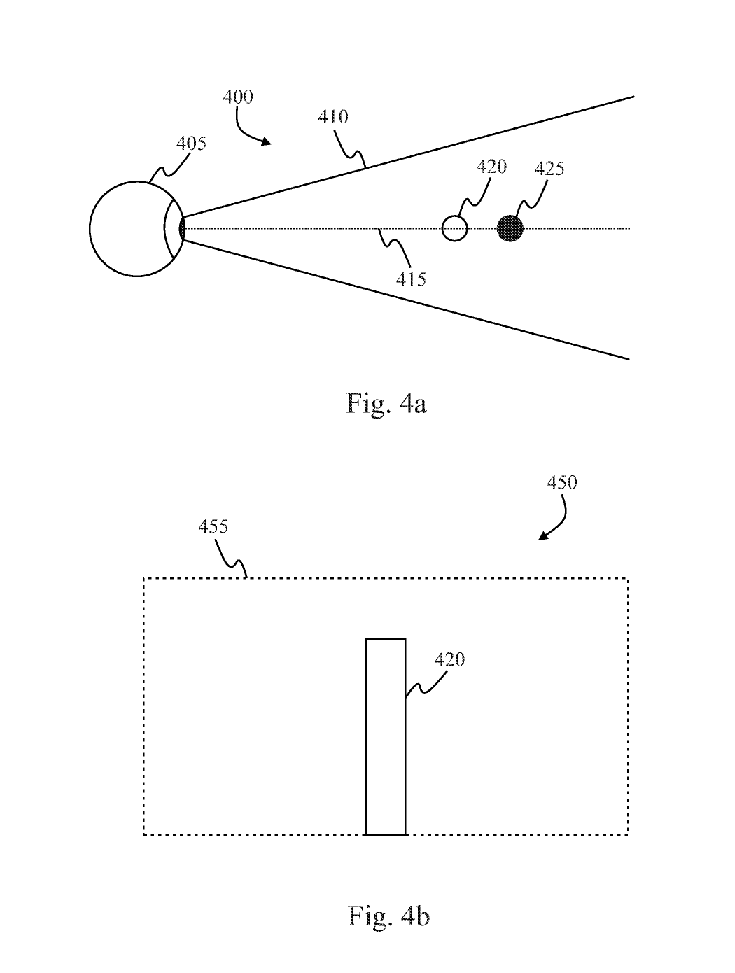

FIG. 4a illustrates a top view of an eye 405 looking straight-on at two posts, a white post 420 and a black post 425. An example field of vision 410 shows the limits of the vision of eye 405. A central axis of vision 415 is illustrated to show the trajectory of sight of eye 405.

FIG. 4b shows a simulated view 450 of what eye 405 perceives. A simulated vision border 455 shows the outer limits of vision from the perspective of eye 405. From the simulated view 450, it is shown that white post 420 obstructs the eye 405 from viewing of black post 425 when looking straight, in the manner shown in FIG. 4a.

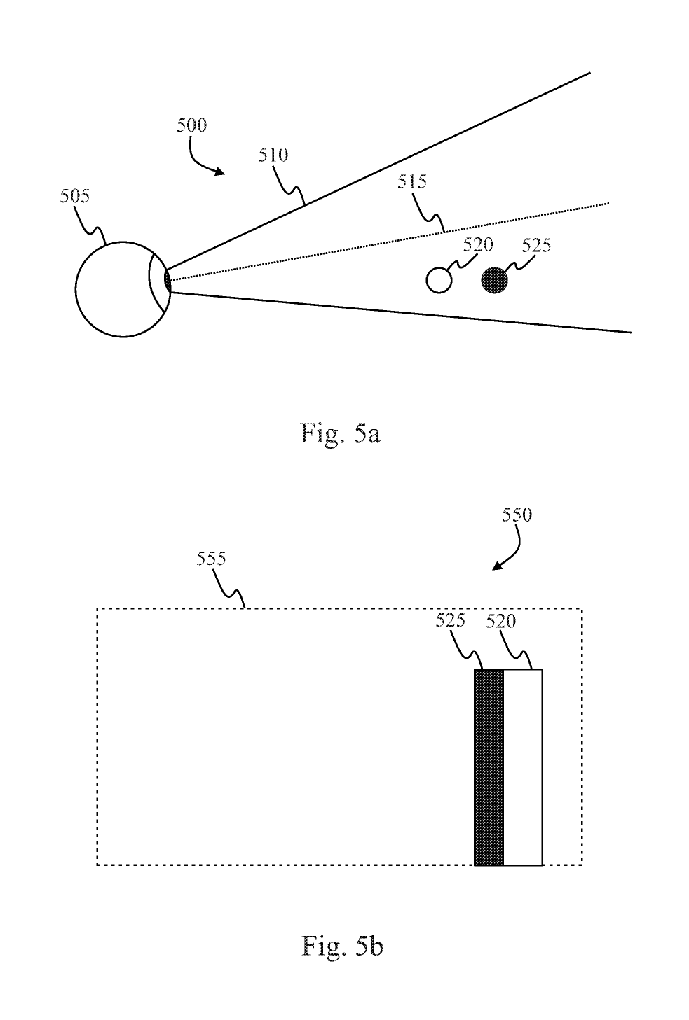

FIG. 5a illustrates a top view of an eye 505 as it turns slightly to the left of a white post 520 and a black post 525. An example field of vision 510 shows the limits of the eye's 505 vision. A center of vision 515 is illustrated to show the trajectory of sight of eye 505.

FIG. 5b shows a simulated view 550 of what eye 505 perceives. A simulated vision border 555 shows the outer limits of vision from the perspective of eye 505. From the simulated view 550, it is shown that a parallax effect between white post 520 and black post 525 has occurred with the turning of eye 505 to the left. The eye 505 may now be able to get a glimpse of black post 525 from behind white post 520.

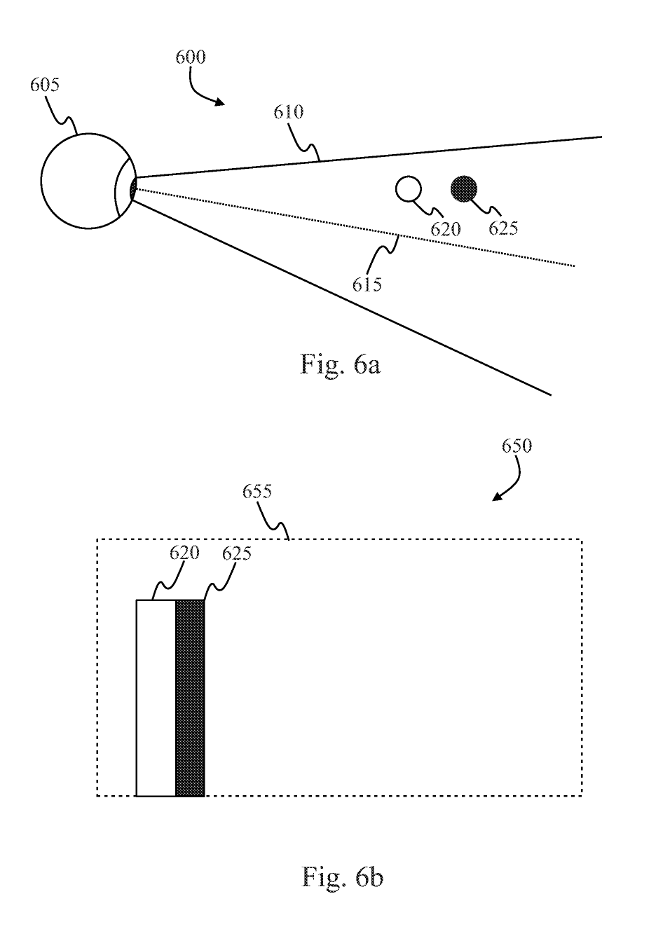

FIG. 6a illustrates a top view of an eye 605 as it turns slightly to the right of a white post 620 and a black post 625. An example field of vision 610 shows the limits of the eye's 605 vision. A center of vision 615 is illustrated to show the trajectory of sight of eye 605.

FIG. 6b shows a simulated view 650 of what eye 605 perceives. A simulated vision border 655 shows the outer limits of vision from the perspective of eye 605. From the simulated view 650, it is shown that a parallax effect between white post 620 and black post 625 has occurred with the turning of eye 605 to the right. The eye 605 may now be able to get a glimpse of black post 625 from behind white post 620.

The skilled person will understand that the specific examples of FIGS. 4 a and b, 5 a and b, and 6 a and b, depict stop-motion situations, but that as a user's eyes are moving, the positions of the posts will be perceived to move relative to one another in concert with the movement of the user's eyes.

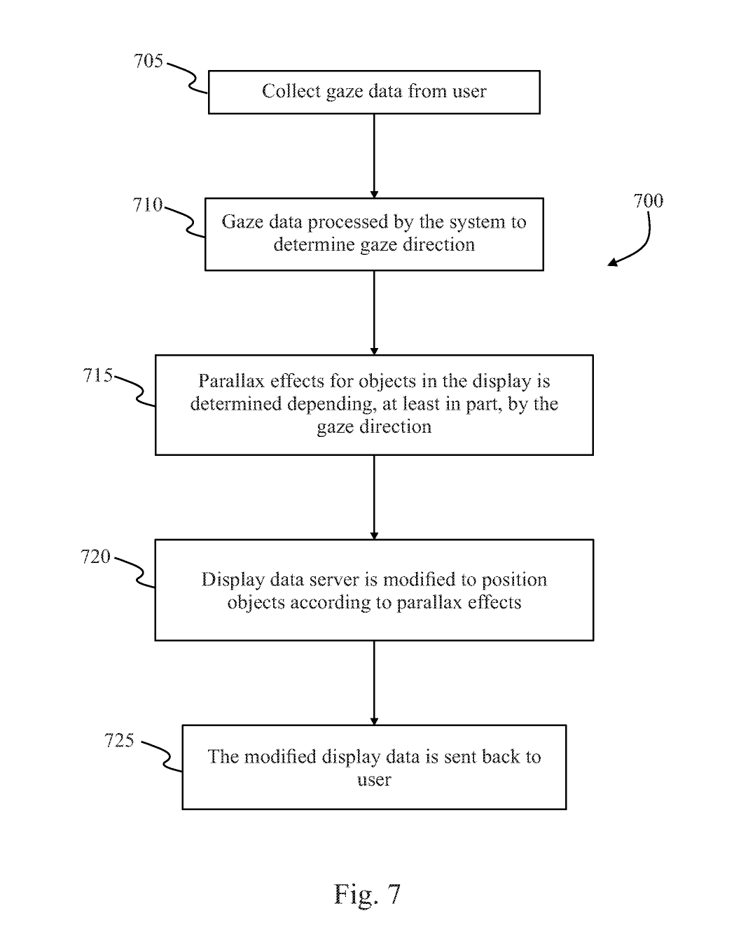

FIG. 7 is a flowchart 700 outlining the steps according to one embodiment of the current invention. At step 705, gaze data is collected via an imaging device. At step 710 the gaze data is processed by the system to determine a gaze direction of the primary user. At step 715, a parallax effect for the display is determined by the system based, at least in part, by the gaze direction of the primary user. At step 720, the display data server is modified to position objects according to the parallax effects as determined by the system in step 715. At step 725 modified display data is transmitted to displays at the user's station. The steps in this flowchart may be run once, or as many times as is necessary.

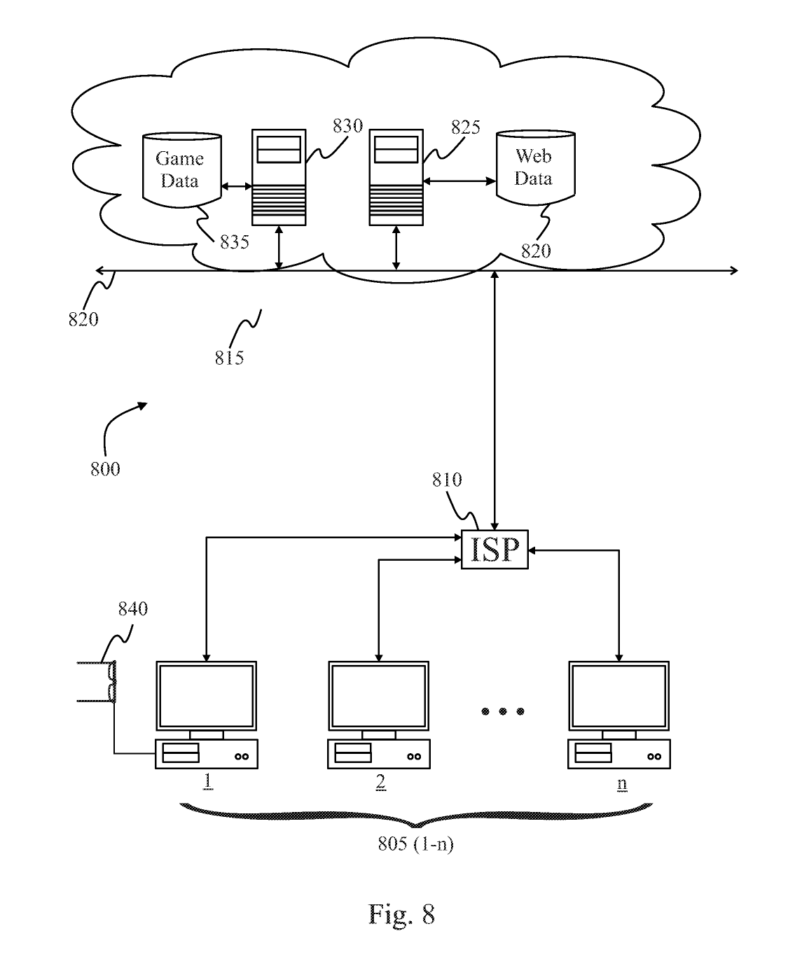

FIG. 8 is an example of a network architecture 800 in which various embodiments of the inventive concept may be implemented. A plurality of users 805(1-n) may connect to an Internet-connected system 815, which may comprise one or more web-page servers 825, and one or more game-servers 830 through Internet Service Providers 810. The device that user 805 may use to connect to the Internet-connected system 815 may comprise, but not be limited to, a desktop computer, a laptop computer, a mobile phone, or a tablet. A head-mounted display 840 is shown coupled to station 805(1), and may connect hard-wired or wirelessly. Such devices may be coupled to the other stations represented as well, but are not shown in the figure.

In some embodiments, the web-page server 825 and game server 830 may be a single server. Although only one of each server type is shown in the illustration, it is understood that there are no limits on the number of servers that may be implemented. The web-page server 825 may serve as a front-end to the game server 830 and may be responsible for, but not limited to, processing user sign-ups, serving as a front-end to choose a game to play, and game-related news and general information regarding a game to the user 805. This information may all be stored on a Web data repository 820. The game server 830 may contain the information that pertains to rendering of the virtual environment, which may comprise, but not be limited to, coordinates and descriptors of objects to be rendered in a virtual environment, and information pertaining to other players connected to the game server 830. This information may be stored on a game data repository 835. The storage type used for the Web data repository 820 and the game data repository 835 may comprise any form of non-volatile storage known in the art. In some embodiments, the Web data repository 820 and game data repository 835 may be combined.

Once the user 805 connects to the gamer server 830, the game server 830 may begin collecting and processing gaze data from the user 805 according to one embodiment of the present invention. The game server 830 may transmit modified display data back to user 805. It will be apparent to one with skill in the art, that the embodiments described above are specific examples of a single broader invention which may have greater scope than any of the singular descriptions taught. There may be many alterations made in the descriptions without departing from the spirit and scope of the present invention.

1. A method, comprising:
collecting gaze data establishing eye position and changes in eye position over time by a first imaging device fixed in position relative to a player viewing a display of a virtual reality environment on a screen fixed relative to the imaging device, and focused to image a first eye of the player;
providing the gaze data to a first data repository coupled to a processor that is determining and serving display data for rendering the virtual environment in the display;
determining gaze direction for the player's first eye relative to a coordinate system associated with the virtual environment;
determining parallax effects for objects in the display by the processor at least in part dependent on the gaze direction; and
modifying the display data server to position objects in the display according to the parallax effects determined.

2. The method of claim 1, wherein the screen is a single opaque screen in a head-mounted device.

3. The method of claim 1, wherein the display is a head-mounted device with semi-transparent screens.

4. The method of claim 1, wherein the display is a stand-alone display monitor.

5. The method of claim 1, wherein the processor and data repository are components of computer circuitry implemented local to the display screen.

6. The method of claim 1, wherein the processor and data repository are components of a network-connected server remote from the imaging device and the display screen, wherein the gaze data is transmitted over the network to the network-connected server, the gaze direction and parallax effects are determined by the processor at the network-connected server, and the display data is transmitted over the network from the network-connected server to the display screen.

7. The method of claim 1 further comprising a second camera focused on a second eye of the player, providing gaze data for the second eye to the data repository, wherein gaze direction and parallax effects are determined for both of the player's eyes.

8. A system, comprising:
a first imaging device fixed in position relative to a player viewing a display of a virtual reality environment on a screen fixed relative to the imaging device, and focused to image a first eye of the player, the first imaging device collecting gaze data establishing eye position and changes in eye position over time; and
a first data repository coupled to a processor that is determining and serving display data for rendering the virtual environment in the display, the data repository receiving the gaze data from the first imaging device;
wherein the processor determines gaze direction for the player's first eye relative to a coordinate system associated with the virtual environment, determines parallax effects for objects in the display, at least in part dependent on the gaze direction, and modifies the display data served to position objects in the display according to the parallax effects determined.

9. The system of claim 8, wherein the screen is a single opaque screen in a head-mounted device.

10. The system of claim 8, wherein the display is a head-mounted device with semi-transparent screens.

11. The system of claim 8, wherein the display is a stand-alone display monitor.

12. The system of claim 8, wherein the processor and data repository are components of computer circuitry implemented local to the display screen.

13. The system of claim 8, wherein the processor and data repository are components of a network-connected server remote from the imaging device and the display screen, wherein the gaze data is transmitted over the network to the network-connected server, the gaze direction and parallax effects are determined by the processor at the network-connected server, and the display data is transmitted over the network from the network-connected server to the display screen.

14. The system of claim 8 further comprising a second camera focused on a second eye of the player, providing gaze data for the second eye to the data repository, wherein gaze direction and parallax effects are determined for both of the player's eyes.
